(19) United States
(12) Patent Application Publication
(10) Pub. No.: US 2015/0032490 A1
(43) Pub. Date: Jan. 29, 2015

(54) IDENTIFYING DRIVER REPORT DATA BASED UPON TRANSPORTATION SYSTEM SCHEDULE INFORMATION

(71) Applicant: Xerox Corporation, Norwalk, CT (US)

(72) Inventor: John C. Handley, Fairport, NY (US)

(73) Assignee: Xerox Corporation, Norwalk, CT (US)

(21) Appl. No.: 13/951,587

(22) Filed: Jul. 26, 2013

(51) Int. Cl. G06Q 50/30; G06Q 10/06

(52) U.S. Cl. CPC G06Q 50/30; G06Q 10/06311
USPC 705/7.13

(57) ABSTRACT

In a transportation system, identifying factors that contribute to schedule deviation provides for improving the operation of the system. A processing device collects operational information related to the operation of at least one vehicle along a transportation route. The device determines a plurality of actual scheduled arrivals for the transportation route and compare the operating information with the actual scheduled arrivals to determine mean delay data for each driver. The device determines schedule deviation for each driver based upon the operating information and fits the mean delay data for each driver, standard deviation delay data for each driver, and the schedule deviation information for each driver into a results set. The device fits the data using a maximum likelihood modeling technique and/or a Bayesian modeling technique. The results set are presented to a manager or another similar authority role in the transportation system for further action.

### BACKGROUND

The present disclosure relates to identifying driver specific data related to schedule adherence in a transportation system, such as a public bus, train or plane system. More specifically, the present disclosure relates to identifying and displaying the impact of drivers' behavior on schedule adherence over a specific time period.

Many service providers monitor and analyze analytics related to the services they provide. For example, computer aided dispatch/automated vehicle location (CAD/AVL) is a system in which public transportation vehicle positions are determined through a global positioning system (GPS) and transmitted to a central server located at a transit agency's operations center and stored in a database for later use. The CAD/AVL system also typically includes two-way radio communication by which a transit system operator can communicate with vehicle drivers. The CAD/AVL system may further log and transmit incident information including an event identifier (ID) and a time stamp related to various events that occur during operation of the vehicle. For example, for a public bus system, logged incidents can include door opening and closing, driver logging on or off, wheel chair lift usage, bike rack usage, current bus condition, and other similar events. Some incidents are automatically logged by the system as they are received from vehicle on-board diagnostic systems or other data collection devices, while others are entered into the system manually by the operator of the vehicle.

For a typical public transportation company, service reliability is defined as variability of service attributes. Problems with reliability are ascribed to inherent variability in the system, especially demand for transit, operator performance, traffic, weather, road construction, crashes, and other similar unavoidable or unforeseen events. As transportation providers cannot control all aspects of operation owing to these random and unpredictable disturbances, they must adjust to the disturbances to maximize reliability. Several components that determine reliable service are schedule adherence, maintenance of uniform headways (e.g., the time between vehicles arriving in a transportation system), minimal variance of maximum passenger loads, and overall trip times. However, most public transportation companies put a greater importance on schedule adherence.

Schedule adherence for a specific transportation route is generally determined by a multitude of factors. One factor is the degree to which the vehicle was late or early at a previous stop. Deviations can propagate throughout the route, but a driver can compensate/overcompensate as well. Another factor impacting schedule adherence is the distance between stops. For example, the longer the distance, the greater the opportunity a driver has to compensate for a previous delay. Yet another factor is the number of people alighting and boarding a vehicle at a stop. Another factor is the actual driver of the vehicle. Based upon their skills, training and other experience, a driver may compensate in various manners to adjust schedule adherence for a particular route. Part of the job of a driver is to adhere to the schedule on route while dealing with traffic, obeying traffic laws, and keeping passengers safe. Thus, a driver is limited in how much he or she can compensate to improve schedule adherence during actual operation of the vehicle.

By using a CAD/AVL system, transit operators can easily obtain current and historical operation information related to a vehicle or a fleet of vehicles. However, the information shows an overall trend of the data, not individual data related to specific drivers and how the performance of that driver impacts overall schedule adherence.

### SUMMARY

In one general respect, the embodiments discloses a method of identifying factors that contribute to schedule deviation in a transportation system. The method includes collecting operating information related to the operation of at least one vehicle along a transportation route, determining a plurality of actual scheduled arrivals for the transportation route, comparing the operating information with the actual scheduled arrivals to determine mean delay data for each driver, determining schedule deviation for each driver based upon the operating information, fitting the mean delay data for each driver, standard deviation delay data for each driver, and the schedule deviation information for each driver into a results set, and presenting the results set.

In another general respect, the embodiments disclose a monitoring system for identifying factors that contribute to schedule deviation in a transportation system. The system includes a plurality of transportation vehicles, wherein each transportation vehicle has at least one associated driver and a data collection system configured to collect operating information related to the operation of the vehicle and a processing device operably connected to each of the data collection systems. The processing device may be configured to collect the operating information related to operation of at least one vehicle along a transportation route, determine a plurality of actual scheduled arrivals for the transportation route, compare the operating information with the actual scheduled arrivals to determine mean delay data for each driver, determine schedule deviation for each driver based upon the operating information, fit the mean delay data for each driver, standard deviation delay data for each driver, and the schedule deviation information for each driver into a results set, and present the results set.

In another general respect, the embodiments disclose a device for identifying factors that contribute to schedule deviation in a transportation system. The device includes a processing device, a display device operably connected to the processing device, and a computer readable medium in communication with the processing device. The computer readable medium may include one or more programming instructions for causing the processing device to collect operating information related to the operation of at least one vehicle along a transportation route, determine a plurality of actual scheduled arrivals for the transportation route, compare the operating information with the actual scheduled arrivals to determine mean delay data for each driver, determine schedule deviation for each driver based upon the operating information, fit the mean delay data for each driver, standard deviation delay data for each driver, and the schedule deviation information for each driver into a results set, and display, on the display device, the results set.

### BRIEF DESCRIPTION OF THE DRAWINGS

FIG. 1 depicts a plot illustrating driver specific delay according to an embodiment.

FIG. 2 depicts a sample flow chart for determining driver information and schedule adherence related to the operation of a transportation vehicle according to an embodiment.

FIG. 3 depicts various embodiments of a computing device for implementing the various methods and processes described herein.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

As used herein, a “computing device” refers to a device that processes data in order to perform one or more functions. A computing device may include any processor-based device such as, for example, a server, a personal computer, a personal digital assistant, a web-enabled phone, a smart terminal, a dumb terminal and/or other electronic device capable of communicating in a networked environment. A computing device may interpret and execute instructions.

A “regression model” is a model based upon an analysis of several variables using regression analysis techniques to determine a relationship between a dependent variable and one or more independent variables.

The present disclosure is directed to a method and system for identifying and displaying the impact of drivers' behavior on schedule adherence over a time period, for example, on an ongoing daily basis. Schedule adherence in a transportation system is one of the most important aspects of quality of service. In the United States, federally funded transit agencies are required to report their on-time performance to the federal government. Operators and managers of transportation systems often do not know the impact of various factors on schedule adherence, including driver impact and various factors that contribute to a driver's performance. In the present disclosure, the methods and systems described account for previous delays, distances traveled between stops, and number of passengers alighting and boarding a vehicle when identifying driver impact on schedule adherence. The present disclosure also includes a user interface for displaying information related to the performance of a driver, as well as for displaying information related to additional steps to be taken with regard to the drive, such as providing additional compensation (for high levels of performance), providing additional training, or terminating a driver.

In a related application, U.S. patent application Ser. No. 13/563,001, filed Jul. 31, 2012 and entitled “Identifying Contributions to Transportation System Schedule Deviation,” the content of which is hereby incorporated by reference in its entirety, a transportation system may use a computer aided dispatch/automated vehicle location (CAD/AVL) system to monitor and store data that is used to determine a historical statistics for a particular route (e.g., later arrivals at a transit stop, wheelchair loading/unloading, bike rack loading/unloading). This information may be used to create a plot of the historical statistical information and fit one or more count regression models to the plot. The model fit may then be assessed to determine one or more contributions to schedule deviation for the route. The present disclosure expands upon these concepts to provide additional focus on driver specific impact on schedule adherence.

In the present disclosure, determined driver effects on the schedule adherence mean (per the usual regression formulation) and the effect on the standard deviation of schedule adherence is estimated using available data. In order to fairly assess the effect of driver performance on schedule adherence, a threshold of observations for an individual driver over a specific period of time may be set. For example, the threshold may be set at 30 observations per driver per day. For an entire transportation system that may include hundreds of drivers, this provides a robust data set from which to analyze the impact of each driver on the overall transportation system schedule adherence.

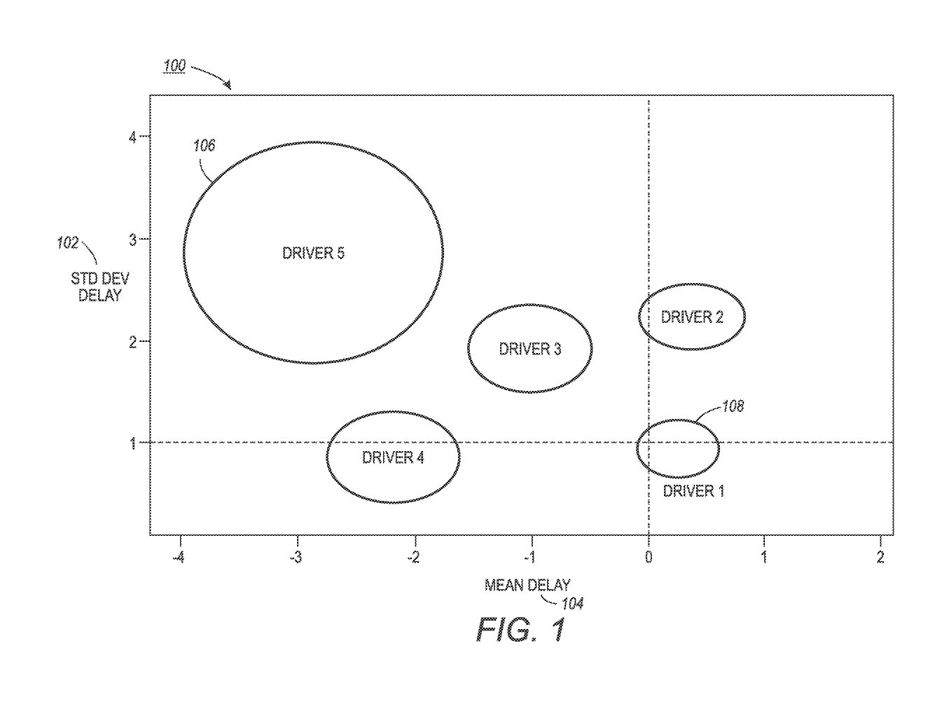

In schedule adherence, being consistently late or early is bad, but being highly variable is bad as well. One desires both accuracy and precision in driver performance. Using the techniques described herein, driver accuracy and precision can be displayed in a single results set. As shown in FIG. 1, graph 100 illustrates a graph of accuracy and precision for a group of drivers. As shown in graph 100, the standard deviation delay (y-axis 102) and the mean delay (x-axis 104) for a group of five drivers is illustrated. However, it should be noted that five drivers are shown by way of example only, and a graph may include various numbers of drivers.

The effect of the mean delay behavior is additive to the entire transportation system. However, the effect of the standard deviation delay is multiplicative across the entire transportation system. Thus, in this example, an effect of 1.0 on the standard deviation has no effect on the overall transportation system (as it multiplies the overall standard deviation by 1.0). A number greater than one increases the overall standard deviation of the transportation system and, conversely, a number less than one decreases the overall standard deviation of the transportation system.

As shown in FIG. 1, driver 5, represented by circle 106, is a poor performer. As shown, driver 5 is consistently late (having a mean delay of about −3) and is increasing the overall standard deviation by a factor of nearly three. Conversely, driver 1, represented by circle 108, is performing well, having a mean delay near zero and a multiplicative contribution to the overall standard deviation of about 1.

In order to calculate mean delay, data directly related to arrival times for each driver may be compared to actual set schedule times for a transportation route. However, to determine the standard deviation for each driver, additional information may be considered.

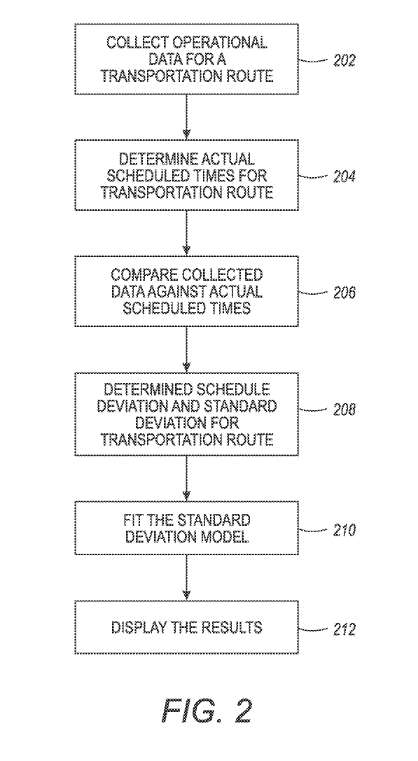

FIG. 2 illustrates a sample flow chart for collecting, determining and displaying various data related to the operation of a transportation vehicle such as a bus. Upon starting operation of the transportation vehicle, a set of initial data may be collected 202. For example, if the transportation vehicle is a bus, the operator of the bus may enter their driver identification, route number, bus number, and other related information into the CAD/AVL system. The CAD/AVL system may collect 202 this data, along with other data such as a timestamp and the geographic location of the bus.

During operation of the bus, the CAD/AVL system may collect 202 additional data such as an arrival time at each stop, duration of time spent at each stop, departure time from each stop, travel time between each stop, average travel speed, maximum travel speed, number of times a wheelchair ramp is used, and other related information. Additionally, the operator of the vehicle may manually enter additional information into the CAD/AVL system to be recorded. For example, each time a bike rack is accessed the driver may record this information into the CAD/AVL system.

Depending on the capabilities of the CAD/AVL system, the system may distribute the collected 202 data to a central server according to a set schedule. For example, depending on the network connection of the CAD/AVL system, the system may upload the data each time a new entry is collected 202. This information may be used to update schedule data during real-time operation of the vehicle. For example, a display board at a transportation station indicating the current operating status of the vehicle may be updated to reflect any changes to the current status. Alternatively, the information may be distributed from the CAD/AVL system at the end of a route or the end of an operator's shift.

The system may additionally determine 204 a set schedule for the transportation route being analyzed, including the actual scheduled arrival times for each stop on the transportation route. The system may then compare 206 collected time data and the actual scheduled arrival times related to observed delays measured along the transportation route to determine mean delay values for the driver.

Additionally, the standard deviation may be determined 208 for each driver. For example, the standard deviation may be determined 208 by:

Yₜ|_{Y}_{_{t−2}}=_{y}_{_{t−5}}˜N(μ(yₜ₋₁, dₜ₋₁, 0ₜ₋₁, D₁), σ(yₜ₋₁, dₜ₋₁, 0ₜ₋₁, D₁),

where

μ(yₜ₋₁, dₜ₋₁, 0ₜ₋₁, D₁)=α₀+α₁yₜ₋₁+α₂d_{t-1,t}+α₃oₜ₋₁+αDₜ, and

log{σ(yₜ₋₁, dₜ₋₁, 0ₜ₋₁, D₁)}=β₀+β₁yₜ₋₁+β₂d_{t-1,t}+β₃oₜ₋₁+bDₜ.

In the above equations:
yₜ₋₁ represents the observed delay at previous time point t−1;
d_{t-1,t} represents the distance between the stop represented by time point t−1 and the stop represented by time point t;
oₜ₋₁ represents the total number of passengers alighting and boarding the vehicle at time point t−1; and
Dₜ represents the specific driver arriving at time point t.

Thus, in order to determine 208 the standard deviation, the delay associated with the previous stop, the distance from time point t−1 to t, and total number of people alighting and boarding, and the driver specific contribution may affect mean derivation from the schedule and the standard deviation of schedule deviation.

Based upon the deviation information, the system may fit 210 the mean delay and the standard deviation information. Modeling the deviation information may include constructing a plurality of models such that each combination of contributing factors is included in at least one model. Using one or more models, such as a regression model including all combinations of the contributing factors, may be fitted by maximum likelihood or Bayesian techniques (where mean and precision of the normal distribution are random variables with priors on all the regression coefficients).

For example, in Bayesian modeling, schedule variance may be replaced by precision, which is the inverse of standard deviation, where:

Yᵢ|_{Y}_{_{t−2}}=_{y}_{_{i−2}}˜N(μᵢτᵢ),

where

μᵢ=α₁yᵢ₋₁+α₂d_{i-1,i}+α₃oᵢ₋₁+γ_{D}_{ᵢ}

and

log(τᵢ)=−2(β₁yᵢ₋₁+β₂dᵢ₋₁+β₃0ᵢ₋₁+ξ_{D}_{ᵢ}).

In this example set of equations:

αⱼ˜N(0,0.0001), j=1, 2, 3;

βⱼ˜N(0,0.0001), j=1, 2, 3;

γ_{D}˜N(0,0.0001), j=1, 2, 3; and

ξ_{D}˜N(0,0.0001), j=1, 2, 3.

Additionally, D may cover a range as observed for all drivers. In this example, a Bayesian model may be easily fit using a standard statistical R package.

Other factors that could be included in the model may include hour of the day, day of the week, measures of traffic congestion (including average vehicle speed), the number of stop lights between stops, the number of ad hoc boardings and alightings (not scheduled stops), attributes of the driver including level of experience, and measured dwell time (the total time the vehicle door was open).

An example of a maximum likelihood technique is the R package for generalized additive models with location scale and shape (GAMLSS). A key feature of the model as determined using a maximum likelihood technique such as GAMLSS is that it extends the regression model to include covariates for the standard deviation in addition to the mean as in ordinary regression. Using Bayesian methods provides a more extensible model, however performing such modeling may use more time and computational resources.

The results may be displayed 212 to a user of the system via a display device. For example, graph 100 as shown in FIG. 1 may represent a results set for a particular transportation system, or a particular route within a transportation system. Based upon the results, additional analysis may be done, or a set of suggested actions may be determined. For example, the suggested actions may include additional driver training, adjustment to a driver's compensation, terminating a driver, and other similar actions.

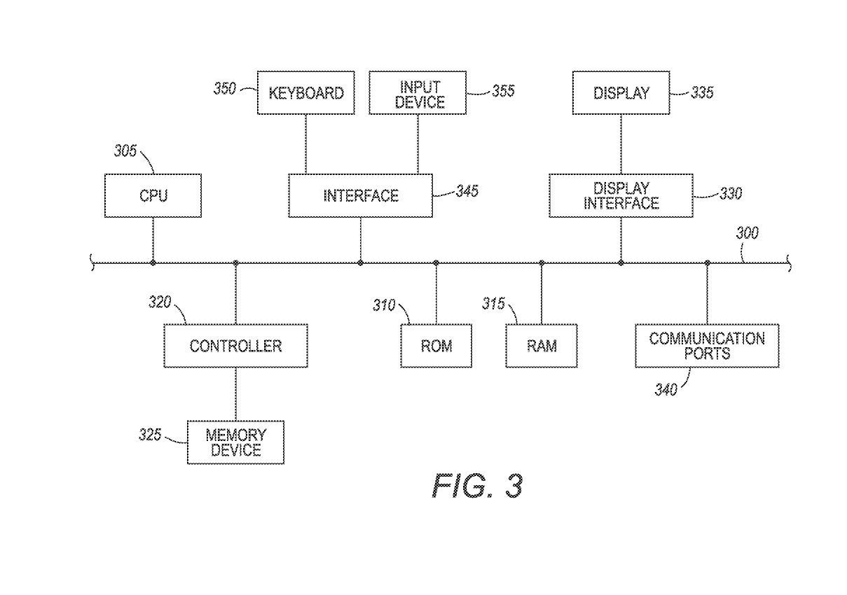

The calculations and derivations as described above may be performed and implemented by an operator of a computing device located at an operations center (e.g., a central operations center for a public transportation provider). FIG. 3 depicts a block diagram of internal hardware that may be used to contain or implement the various computer processes and systems as discussed above. An electrical bus 300 serves as the main information highway interconnecting the other illustrated components of the hardware. CPU 305 is the central processing unit of the system, performing calculations and logic operations required to execute a program. CPU 305, alone or in conjunction with one or more of the other elements disclosed in FIG. 3, is a processing device, computing device or processor as such terms are used within this disclosure. Read only memory (ROM) 310 and random access memory (RAM) 315 constitute examples of memory devices.

A controller 320 interfaces with one or more optional memory devices 325 to the system bus 300. These memory devices 325 may include, for example, an external or internal DVD drive, a CD ROM drive, a hard drive, flash memory, a USB drive or the like. As indicated previously, these various drives and controllers are optional devices. Additionally, the memory devices 325 may be configured to include individual files for storing any software modules or instructions, auxiliary data, incident data, common files for storing groups of contingency tables and/or regression models, or one or more databases for storing the information as discussed above.

Program instructions, software or interactive modules for performing any of the functional steps associated with the processes as described above may be stored in the ROM 310 and/or the RAM 315. Optionally, the program instructions may be stored on a tangible computer readable medium such as a compact disk, a digital disk, flash memory, a memory card, a USB drive, an optical disc storage medium, such as a Blu-ray™ disc, a distributed computer storage platform such as a cloud-based architecture, and/or other recording medium.

An optional display interface 330 may permit information from the bus 300 to be displayed on the display 335 in audio, visual, graphic or alphanumeric format. Communication with external devices may occur using various communication ports 340. A communication port 340 may be attached to a communications network, such as the Internet or a local area network.

The hardware may also include an interface 345 which allows for receipt of data from input devices such as a keyboard 350 or other input device 355 such as a mouse, a joystick, a touch screen, a remote control, a pointing device, a video input device and/or an audio input device.

It should be noted that a public transportation system is described above by way of example only. The processes, systems and methods as taught herein may be applied to any environment where performance based metrics and information are collected for later analysis, and provided services may be altered accordingly based upon the collected information to improve reliability or schedule adherence.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

What is claimed is:

1. A method of identifying factors that contribute to schedule deviation in a transportation system, the method comprising:
collecting, at a processing device, operating information related to the operation of at least one vehicle along a transportation route;
determining, at the processing device, a plurality of actual scheduled arrivals for the transportation route;
comparing, by the processing device, the operating information with the actual scheduled arrivals to determine mean delay data for each driver;
determining, by the processing device, schedule deviation for each driver based upon the operating information;
fitting, by the processing device, the mean delay data for each driver, standard deviation delay data for each driver, and the schedule deviation information for each driver into a results set; and
presenting, by the processing device, the results set.

2. The method of claim 1, wherein determining the schedule deviation further comprises determining the schedule deviation based upon:
observed delay over the transportation route;
distance between stopping points along the transportation route;
number of people boarding the vehicle along the transportation route; and
a driver specific value.

3. The method of claim 1, wherein fitting the schedule deviation information comprises fitting a model of the schedule deviation information using a maximum likelihood modeling technique.

4. The method of claim 1, wherein fitting the schedule deviation information comprises fitting a model of the schedule deviation information using a Bayesian modeling technique.

5. The method of claim 1, wherein the operating information comprises at least vehicle arrival data at each stop along the transportation route, distance information between one or more stops along the transportation route, and a number of people boarding at least one vehicle at one or more stops along the transportation route.

6. The method of claim 1, wherein the results set comprises suggested actions to be taken to reduce schedule deviation caused by driver contribution.

7. The method of claim 6, wherein the suggested actions comprise at least one of additional driver instruction, driver compensation adjustment and driver termination.

8. A monitoring system for identifying factors that contribute to schedule deviation in a transportation system, the system comprising:
a plurality of transportation vehicles, wherein each transportation vehicle has at least one associated driver and a data collection system configured to collect operating information related to the operation of the vehicle; and
a processing device operably connected to each of the data collection systems and configured to:
collect the operating information related to operation of at least one vehicle along a transportation route,
determine a plurality of actual scheduled arrivals for the transportation route,
compare the operating information with the actual scheduled arrivals to determine mean delay data for each driver,
determine schedule deviation for each driver based upon the operating information,
fit the mean delay data for each driver, standard deviation delay data for each driver, and the schedule deviation information for each driver into a results set, and
present the results set.

9. The system of claim 8, wherein determining the schedule deviation further comprises the processing device determining the schedule deviation based upon:
observed delay over the transportation route;
distance between stopping points along the transportation route;
number of people boarding the vehicle along the transportation route; and
a driver specific value.

10. The system of claim 8, wherein fitting the schedule deviation information comprises the processing device fitting a model of the schedule deviation information using a maximum likelihood modeling technique.

11. The system of claim 8, wherein fitting the schedule deviation information comprises the processing device fitting a model of the schedule deviation information using a Bayesian modeling technique.

12. The system of claim 8, wherein the operating information comprises at least vehicle arrival data at each stop along the transportation route, distance information between one or more stops along the transportation route, and a number of people boarding at least one vehicle at one or more stops along the transportation route.

13. The system of claim 8, wherein the results set comprises suggested actions to be taken to reduce schedule deviation caused by driver contribution.

14. The system of claim 13, wherein the suggested actions comprise at least one of additional driver instruction, driver compensation adjustment and driver termination.

15. A device for identifying factors that contribute to schedule deviation in a transportation system, the device comprising:
a processing device;
a display device operably connected to the processing device; and
a computer readable medium in communication with the processing device, the computer readable medium comprising one or more programming instructions for causing the processing device to:
collect operating information related to the operation of at least one vehicle along a transportation route,
determine a plurality of actual scheduled arrivals for the transportation route,
compare the operating information with the actual scheduled arrivals to determine mean delay data for each driver,
determine schedule deviation for each driver based upon the operating information,
fit the mean delay data for each driver, standard deviation delay data for each driver, and the schedule deviation information for each driver into a results set, and
display, on the display device, the results set.

16. The device of claim 15, wherein the one or more instructions for causing the processing device to determine the schedule deviation further comprises one or more instructions for causing the processing device to determine the schedule deviation based upon:
observed delay over the transportation route;
distance between stopping points along the transportation route;
number of people boarding the vehicle along the transportation route; and
a driver specific value.

17. The device of claim 15, wherein the one or more instructions for causing the processing device to fit the schedule deviation information comprises one or more instructions for causing the processing device to fit a model of the schedule deviation information using at least one of a maximum likelihood modeling technique and a Bayesian modeling technique.

18. The device of claim 15, wherein the operating information comprises at least vehicle arrival data at each stop along the transportation route, distance information between one or more stops along the transportation route, and a number of people boarding at least one vehicle at one or more stops along the transportation route.

19. The device of claim 15, wherein the results set comprises suggested actions to be taken to reduce schedule deviation caused by driver contribution.

20. The device of claim 19, wherein the suggested actions comprise at least one of additional driver instruction, driver compensation adjustment and driver termination.
